(19) United States
(12) Patent Application Publication
(10) Pub. No.: US 2026/0058891 A1
(43) Pub. Date: Feb. 26, 2026

(54) SCENARIO-DIFFERENTIATED NETWORK TELEMETRY METHOD AND APPARATUS

(71) Applicant: BEIJING JIAOTONG UNIVERSITY, Beijing (CN)

(72) Inventors: Wei QUAN, Beijing (CN); Hongke ZHANG, Beijing (CN); Mingyuan LIU, Beijing (CN); Xuetong HU, Beijing (CN); Jie LIANG, Beijing (CN); Yuming ZHANG, Beijing (CN); Hongwei WANG, Beijing (CN); Yan LUO, Beijing (CN); Xue ZHANG, Beijing (CN); Liang GUO, Beijing (CN)

(73) Assignee: BEIJING JIAOTONG UNIVESITY, Beijing (CN)

(21) Appl. No.: 19/249,146

(22) Filed: Jun. 25, 2025

(30) Foreign Application Priority Data
Jun. 25, 2024 (CN) 2024108275504

(51) Int. Cl. H04L 43/08; H04L 41/122; H04L 43/12

(52) U.S. Cl. CPC H04L 43/08; H04L 41/122; H04L 43/12

(57) ABSTRACT

A scenario-differentiated network telemetry method is provided. The method is based on an SDN architecture, a control plane is separated from a data plane, the control plane is managed by a central controller, the data plane includes a network device to execute actual packet processing, and the central controller is utilized for decision-making across an entire network; the data plane employs a P4 programmable switch to support functions of network nodes; and units of the method include a network status collection unit, an operation mode switching unit, a probe frequency adjustment unit, and a path control unit, where the operation mode switching unit and the probe frequency adjustment unit are included in a telemetry control unit. Key issues such as achieving integration and switching of multiple INT operation modes, proactive sensing notification functions of the network nodes, and path planning based on priorities of sensing attributes are addressed

### CROSS REFERENCE TO RELATED APPLICATION

This patent application claims the benefit and priority of Chinese Patent Application No. 2024108275504, filed with the China National Intellectual Property Administration on Jun. 25, 2024, the disclosure of which is incorporated by reference herein in its entirety as part of the present application.

### TECHNICAL FIELD

The present disclosure relates to the technical field of communication, and specifically, to a real-time telemetry method for network status information, which is applied to various network scenarios for overall network monitoring, real-time assessment of network statuses, and timely and accurate control of network anomalies. In particular, the present disclosure relates to a scenario-differentiated network telemetry method and apparatus.

### BACKGROUND

The network is a highly complex distributed system; therefore, network management measures are necessary to administer network devices, regulate the operation status of the entire network, and promptly detect and report network faults to terminals. Traditional network monitoring methods are commonly based on a client-server model. For instance, the Simple Network Management Protocol (SNMP) allows a network control and management system to extract statistical data from network elements for non-real-time data collection. Sampled Flow (sFlow) provides a comprehensive view of the network by periodically sampling interface statistics and randomly sampling packet data. NetFlow collects IP flow information at a specified sampling rate and sends aggregated results to a flow collector for analysis. Although these methods were proven effective in the early days of the Internet, their limitations in implementing more complex monitoring are evident. Over the past decade, the Internet has undergone revolutionary changes and dramatic expansion globally. Consequently, networks become increasingly flexible and programmable, but at the cost of added complexity. This implies that troubleshooting network faults and recovering from ambiguous faults (such as congestion, link faults, and black holes) will be more challenging. Hence, network management solutions needs to evolve toward greater automation, enabling dynamic adaptation to current conditions and even autonomous responses to network events. Such automated responses require network telemetry systems capable of providing high-precision, fine-grained events (such as instantaneous traffic bursts) on a fine time scale. The emergence of OpenFlow-based Software Defined Networking (SDN) offers new insights into network monitoring technologies. Data plane switches need to periodically report characteristic information to the SDN controller to achieve centralized network control and management. However, challenges such as relatively high data collection latency, incomplete end-to-end flow information, and scalability issues due to processing overhead on switches still exist, highlighting the need for more programmable data planes. Programming protocol-independent packet processors (P4) and Protocol Oblivious Forwarding (POF) facilitate the implementation of programmable and protocol-independent data planes. Accordingly, the In-band Network Telemetry (INT) technology proposed based on the P4 language provides network operators with the capability to customize network monitoring solutions. INT significantly enhances network visibility and achieves real-time, fine-grained network monitoring, making it easier to diagnose network anomalies while addressing the performance and scalability issues inherent in traditional monitoring methods. INT, with its real-time capabilities, high precision, and independence from the control plane, introduces a new direction for network measurement technology. INT-based measurement solutions and applications have become a research hotspot in contemporary network operation, management, and maintenance.

The scholars worldwide continue to produce research outcomes related to the INT technology. The current INT specification defines, for the first time, the concept of INT and presents a complete INT system prototype along with relevant application cases. To reduce the application overhead of the INT technology, a plurality of studies have introduced new techniques. For example, Source Routing (SR) can intentionally guide the forwarding path of probe packets on the basis of the INT specification, thereby reducing flow table overhead. In most network monitoring scenarios, especially when link capacity utilization is relatively high, per-packet, high-precision, real-time INT monitoring strategies are unnecessary. Kim et al. proposed a P4-based selective INT (sINT) scheme that allows selective insertion of the INT header at the terminal host. Probabilistic In-band Network Telemetry (PINT) classifies telemetry data collection into three modes: packet aggregation, static flow aggregation, and dynamic flow aggregation, ensuring monitoring precision while reducing INT monitoring overhead to the bit level. Another important direction of technical improvement for INT focuses on fault detection within networks. Tang et al. proposed Policy-Aware In-band Network Telemetry (PAINT) for intelligence enabled SDN fault localization based on INT. Tan et al. designed a packet loss monitoring system for INT, called LossSight, which includes functionalities for loss detection, localization, diagnosis, and recovery.

As the technology advances, recent INT application research primarily focuses on optimizing specific demands for single operation modes. However, existing INT operation modes exhibit shortcomings and lack scalability for applications across various network scales. There are two reasons: (1) The on-path INT (INT-MD) approach struggles to achieve high telemetry coverage across the entire network links, resulting in low accuracy for network fault detection particularly under varying traffic durations, characteristics, and distributions. (2) The hop-by-hop INT (INT-MX) approach, which uploads sensing information hop-by-hop, necessitates that each INT transmission node collects sensing data and constructs probe packets for upload, leading to additional bandwidth consumption. Therefore, a key research challenge is how to combine the advantages of both operation modes and effectively schedule telemetry tasks. Additionally, different network scenarios have different demands for the internal perception information of the network. Traditional single network sensing methods are often insufficient for ensuring efficient and real-time monitoring across various network scales. Research into dynamically adjusting sensing tasks and promptly obtaining network status information remains underdeveloped. Consequently, considering the adaptability to network sensing scenarios, two scenario requirements, namely, high real-time performance and anti-packet loss, are used as examples to analyze INT applications:

Due to the end-to-end telemetry mechanism, INT cannot avoid packet loss, and various factors may lead to packet loss during the sensing process. As a result, the reliability of INT sensing is compromised by potential network packet loss, and incomplete telemetry data seriously impacts the performance of upper-layer network telemetry applications. Current research addressing INT packet loss primarily focuses on analyzing the packet loss, such as pinpointing specific locations, recovering from packet losses, or conducting detailed analyses of packet loss, using multiple techniques such as network coding and machine learning. However, in complex network scenarios, these methods are challenging to scale quickly and efficiently for application, and focusing solely on the causes of packet loss introduces various optimization measures that increase the complexity of network sensing technologies.

Given the characteristics of the INT approach of collecting metadata along the path, excessive data transmission through the routing device leads to increased sensing time and overhead. This can be mitigated by optimizing the average number of nodes traversed by each sensing path or the latency of information collection, thereby minimizing overhead in collecting metadata of sensing packets. In terms of reducing overhead, current improvements in INT technology focus on covering all network links while reducing the number of duplicate sensing nodes. However, on the basis of covering all network links, the unequal update rates of sensing information among network nodes are often overlooked, and individual deteriorating nodes cannot undergo separate decoupled sensing operations.

The technical solution of an existing technology retrieved by the inventor is as follows:

The Shandong Provincial Computing Center discloses a gray fault detection and localization method and system based on hybrid INT, relating to the field of fault detection. The method includes: A server collects hop-by-hop telemetry information from passive INT probe packets, to perform a primary detection on faults, and sends, to a controller in a virtual SDN network, a secondary detection instruction for a faulty path. The controller sends a proactive INT probe packet to the server to perform a secondary detection on the faulty path detected in the primary detection. A source server reroutes data traffic of information for a confirmed faulty path. The controller prioritizes all confirmed faulty paths and compares the paths based on priority to obtain fault locations. Then, the controller feeds back the fault locations to the server, and the server searches for all paths associated with the fault locations and ages the paths in advance. This invention integrates proactive and passive INT to compensate for the deficiencies of a single telemetry method, thus improving the efficiency and reliability of network telemetry. This existing technology has the following shortcomings:

(1) This technology locates fault points by sending proactive INT probe packets in two rounds of detection, and then adjusts the paths, primarily focusing on locating the faults through integration of proactive and passive INT probe packets, but neglecting the variations in detection time and cost across different network topological scales.

(2) Both the proactive and passive probe methods involved in this technology utilize per-flow INT detection, which results in delayed fault recovery and the potential for missed fault points due to extended detection time.

The technical solution of another existing technology retrieved by the inventor is as follows:

Guangdong Communications and Networks Institute disclosed an in-band network telemetry method based on network status, including: obtaining network status information during data packet telemetry, and constructing a network status table based on the network status information; configuring a mapping relationship between the network status table and telemetry frequencies, and determining a telemetry frequency through the mapping relationship; and adding, based on the telemetry frequency, telemetry control information to a packet that meets a telemetry condition, to realize INT. This invention can automatically adjust the network telemetry frequency, reducing the additional network overhead caused by network telemetry while ensuring the normal forwarding function of the network.

This existing technology has the following shortcomings:

The second technology adjusts the probe frequency of a sender based on the network status collected via INT, aiming to enhance the real-time performance of network information collection. However, the focus of the technology lies in comparing the number and arrival time of data packets arrived at the sender and receiver, while the actual network situation is complex, with varied scenarios. Singularly comparing the sender and receiver may lead to misjudgment and inaccurate frequency adjustments.

In view of the above descriptions of the existing technologies, technical problems to be resolved by the present disclosure include:

As network devices rapidly evolve and network programmability increases, the demand for network measurement technologies continues to grow, with more new applications becoming increasingly sensitive to changes in network metrics. The conventional INT technology struggles to meet diverse monitoring needs, since collecting large volumes of network status information and uploading to a control terminal significantly increases the workload. Additionally, there are risks of delay and loss of sensing information due to the constraints of fixed-length packets.

Furthermore, due to the complexity, variability, and frequent anomalies within network environments, application of conventional INT technologies lacks adaptability and is inadequate in flexibly addressing the measurement metric requirements of various network service scenarios. The method of the present disclosure aims to address this technical issue by constructing an INT-based hybrid sensing mechanism switching architecture for network status characteristics in different scenarios. The method focuses on key issues such as switching between different INT operation modes, proactive sensing notification of network nodes, and prioritizing path planning based on sensing attributes. The method resolves challenges concerning the difficulty of obtaining network status information and insufficient network sensing responsiveness in complex scenarios. In this way, the method can be used to enhance the efficiency and stability of network operations, ensure the timeliness and accuracy of sensing information, and improve network performance. To overcome the above defects in the prior art, the present disclosure is proposed.

### SUMMARY

The objective of the present disclosure is to address the issues of difficulty in obtaining network status information and insufficient network sensing response capabilities in complex scenarios. The present disclosure proposes a hybrid sensing mechanism switching architecture based on INT, tailored to the network status characteristics in different scenarios. Key issues such as achieving integration and switching of multiple INT operation modes, proactive sensing notification functions of the network nodes, and path planning based on priorities of sensing attributes are addressed. By considering the sensing requirements of different network service scenarios, the present disclosure enables network nodes with proactive sensing functions, improves network information sensing update capabilities, and realizes the hybrid technical implementation of INT operation modes and network node sensing.

In order to achieve the above objective, the present disclosure adopts the following technical solutions:

A scenario-differentiated network telemetry method is provided. The method is based on an SDN architecture, a control plane is separated from a data plane, the control plane is managed by a central controller, the data plane includes a network device to execute actual packet processing, and the central controller is utilized for decision-making across an entire network; the data plane employs a P4 programmable switch to support functions of network nodes; and units of the method include a network status collection unit, an operation mode switching unit, a probe frequency adjustment unit, and a path control unit, where the operation mode switching unit and the probe frequency adjustment unit are included in a telemetry control unit, where
the network status collection unit is configured to collect network scenario information and real-time status information, the network scenario information describes information about a service scenario to which the technology is applied, enabling selection of different operation modes for path probe and adjustment of a probe frequency; and the real-time status information is collected node metadata that accurately reflects an network situation, to facilitate timely regulation of a telemetry strategy, and ensure flexibility and reliability of network probe;
the operation mode switching unit selects a telemetry mode according to characteristics of different network scenarios, path statuses, and features of different INT operation modes through data collected by the network status collection unit;
the probe frequency adjustment unit is configured to receive a proactive sensing notification from an network node, so as to adjust the probe frequency; and
the path control unit is configured to generate, according to a network topology, a plurality of probe paths that evenly cover the network nodes; and re-plan the probe paths based on adjustments to the probe frequency;
a specific working procedure includes the following steps:
step S1: performing initial path planning for a network scenario attribute, and obtaining, by the network collection unit, all network information with an aim of covering all network links;
step S2: generating, by the path control unit according to the network topology and the information fed back by the network collection unit, the plurality of probe paths evenly covering the network nodes;
step S3: performing operation mode selection for different network scales or different network scenarios based on the information collected in the step S1; and
step S4: after collection of the network information is completed, sending the network information into the network scenario information of the network status collection unit for storage;
and further adjusting the probe mode using network resource information, facilitating re-planning of the probe paths, optimization of the probe frequency, and adjustment of node probe actions, where

the network status collection unit, the operation mode switching unit, the probe frequency adjustment unit, and the path control unit are functionally independent but mutually supportive, and the real-time performance and accuracy of sensing are ensured through continuous adjustments of probe behaviors based on the network status information and constant feedback.

Preferably, the network node is provided with a function of autonomously probing network situation changes among the nodes, and a specific method is as follows:
step SI: receiving an INT telemetry packet;
step SII: collecting node status information, and comparing the collected information with a specified threshold according to a preset network index;
step SIII: determining whether metadata collected by an INT probe packet is greater than a preset threshold; and if not, proceeding to step SIV; otherwise, proceeding to step SV;
step SIV: for a telemetry packet not exceeding the threshold, continuing collecting telemetry information along the probe path;
step SV: for a telemetry packet exceeding the threshold, reporting, by a node, telemetry to the central controller for proactive notification, and continuing probing along the path using the telemetry packet; and
step SVI: controlling, by the central controller according to the notification information, a sender to adjust a telemetry frequency.

Preferably, the operation mode switching unit includes a hybrid sensing mode switching method based on the network scenario information or a dynamically adjusted sensing method based on network status changes, and
the hybrid sensing mode switching method based on the network scenario information specifically includes:
firstly, analyzing network scenario sensing requirements, constructing a multi-objective optimization problem for different scenario requirements, and selecting reasonable information according to priorities of the sensing requirements in different scenarios; and
secondly, according to a hybrid telemetry switching model, constructing a constraint condition set based on constraints including network resource availability, dependencies of scenario telemetry requirements, probe path directions, and sensing effect requirements; and
the dynamically adjusted sensing method based on network status changes specifically includes:
in an adaptive switching framework, considering a complex network situation and different telemetry data collection requirements, setting a sensing parameter threshold based on flexible switching between sensing operation modes, and dynamically adjusting, by the node, the probe frequency as needed, such that more measurement possibilities is realized by dynamic interaction between the nodes, and flexible and efficient telemetry tasks are realized.

Preferably, the probe frequency adjustment unit is linked to the specified threshold of the network nodes, to perform multiple regulations of different probe frequencies according to whether the threshold is exceeded or not and a degree of exceeding the threshold.

Preferably, in the step S4,
re-planning of the probe path includes, but is not limited to, using the network scenario information, a real-time link transmission status provided in real-time recovered network status information, and a node queue depth, or a real-time feedback of other landmark network situations, to ensure high coverage of network information probe links and high volume of information collection from network resources in combination with scenario requirements; or
a separate probe path is set for an abnormal node, and a hop-by-hop probe mode is adopted to ensure accuracy and completeness of collected probe information; and to prevent node deterioration caused by probe behaviors, a path redundancy operation is performed on an upstream node directly connected to the abnormal node, to avoid excessive probe traffic passing through the abnormal node.

Preferably, in the step S4,
the probe frequency optimization includes real-time updates to probe frequencies for different paths based on an initial probe frequency and an update rate of the network information.

Preferably, in the step S4,
adjustment of node probe actions primarily focuses on switching probe methods and selecting a probe action for an network abnormal node, comprising: selecting and switching to an appropriate operation mode for the node based on changes in the network scenarios or link conditions, where since the network node has a proactive sensing function, the node detects an network anomaly timely, and performs a proactive information upload action, enhancing a capacity of the entire system for processing anomalies.

The present disclosure further provides a network telemetry apparatus adopting the scenario-differentiated network telemetry method, including:
a central controller for managing a control plane, and a data plane for a network device to execute actual packet processing, where the central controller is utilized for decision-making across an entire network, and the data plane adopts a P4 programmable switch to support functions of network nodes; and
a network status collection unit, an operation mode switching unit, a probe frequency adjustment unit, and a path control unit, where the operation mode switching unit and the probe frequency adjustment unit are included in a telemetry control unit, where
the network status collection unit is configured to collect network scenario information and real-time status information, the network scenario information describes information about a service scenario to which the technology is applied, enabling selection of different operation modes for path probe and adjustment of a probe frequency; and the real-time status information is collected node metadata that accurately reflects an network situation, to facilitate timely regulation of a telemetry strategy, and ensure flexibility and reliability of network probe;
the operation mode switching unit selects a telemetry mode according to characteristics of different network scenarios, path statuses, and features of different INT operation modes through data collected by the network status collection unit;
the probe frequency adjustment unit is configured to receive a proactive sensing notification from an network node, so as to adjust the probe frequency;
the path control unit is configured to generate, according to a network topology, a plurality of probe paths that evenly cover the network nodes; and re-plan the probe path based on adjustments to the probe frequency; and
the network status collection unit, the operation mode switching unit, the probe frequency adjustment unit, and the path control unit are functionally independent but mutually supportive, and the real-time performance and accuracy of sensing are ensured through continuous adjustments of probe behaviors based on the network status information and constant feedback.

The present disclosure further provides an electronic device, including a processor and a memory, where when the processor executes a computer program stored in the memory, the above scenario-differentiated network telemetry method is implemented.

The present disclosure further provides a computer readable storage medium, storing a computer program, where when the computer program is executed by a processor, the above scenario-differentiated network telemetry method is implemented.

The beneficial effects of the present disclosure are as follows:

With the rapid development of SDNs and programmable data planes, INT, as an advanced network monitoring technique, has received widespread attention. INT utilizes packets to carry network telemetry information and collects network status information hop by hop for congestion control, traffic scheduling, anomaly detection, and other purposes. The network information hybrid sensing method provided in the method of the present disclosure combines two operation modes to realize efficient scheduling of telemetry tasks. Additionally, in different network service scenarios, such as scenarios requiring anti-packet loss and high real-time performance, this method can meet diverse telemetry needs, realize flexible telemetry strategies, and obtain accurate telemetry information. The present disclosure offers the following advantages:

(1) The method of the present disclosure considers the unequal update rates of sensing information among the network nodes and decouples the sensing operations of individual deteriorating nodes. While maintaining comprehensive telemetry coverage across the network, the method takes into account the sensing demands of different network service scenarios, increases the actions of network nodes, and improves the overall update capability of network information sensing.

(2) As the technology evolves, current INT application research primarily focuses on optimizing specific demands for single operation modes. However, existing INT operation modes exhibit shortcomings and lack scalability for applications across various network scales. By combining two INT probe modes, the method of the present disclosure balances the advantages of both operation modes and enables mechanism switching based on different network scenario requirements, such as the network scales, to achieve better sensing performance.

(3) Furthermore, since P4 language is used to configure switching nodes, the method of the present disclosure has three characteristics: reconfigurability, platform independence, and protocol independence.

\textcircled{1} Reconfigurability means that users of the method of the present disclosure can flexibly define data plane processing behaviors without changing hardware. According to different user forwarding requirements for data plane nodes, P4 code can be changed without replacing devices or waiting for new devices to be developed. This supports dynamic changes to packets after the forwarding logic code is compiled and deployed on a specific platform.

\textcircled{2} Protocol independence means that P4 code is not bound to specific network protocols. This allows switching nodes to use network protocols on demand, fully utilizing the device resources.

\textcircled{3} Platform independence means that developers can write packet processing logic independent of a specific underlying operation platform. The code can be quickly ported between different platforms such as hardware switches, field programmable gate arrays (FPGAs), smart network interface cards (SmartNICs), and software switches, through the device-related backend compiler, reducing the burden on developers and improving development efficiency.

Term explanation:
\textcircled{1} Software defined network: Software defined network (SDN) is a new network architecture proposed by the Clean-Slate research group at Stanford University, and it is a form of network virtualization. Its core technology, OpenFlow, separates the control plane and data plane of network devices, allowing flexible control of network traffic and making networks more intelligent as pipelines, providing a good platform for the innovation of core networks and applications.

\textcircled{2} Programming Protocol-independent Packet Processors: Programming protocol-independent packet processors (P4) is a domain-specific language for network devices, specifying how data plane devices (such as switches, NICs, routers, and filters) process packets.

\textcircled{3} In-band Network Telemetry: In-band Network Telemetry (INT) is a network measurement technology that fundamentally collects, carries, organizes, and reports network statuses using data plane services, without using a separate control plane to manage traffic for this information collection.

### BRIEF DESCRIPTION OF THE DRAWINGS

To describe the technical solutions in the examples of the present disclosure or in the prior art more clearly, the following briefly describes the accompanying drawings required for describing the examples or the prior art. Apparently, the accompanying drawings in the following description show only some examples of the present disclosure, and a person of ordinary skill in the art may still derive other accompanying drawings from these accompanying drawings without creative efforts.

FIG. 1 is a general framework diagram of the present disclosure;

FIG. 2 is a schematic structural diagram of units in a scenario-differentiated network telemetry method according to the present disclosure;

FIG. 3 is a schematic diagram of an INT-MD operation mode in the prior art;

FIG. 4 is a schematic diagram of an INT-MX operation mode in the prior art;

FIG. 5 is a schematic structural diagram of a node proactive sensing process;

FIG. 6 is a flowchart of node proactive sensing;

FIG. 7 is a schematic diagram of a sensing process for a service scenario requires high real-time performance;

FIG. 8 is a flowchart of dynamically adjusting a probe path based on network status changes; and

FIG. 9 is a schematic diagram of an example in which the present disclosure is applied to a low-latency scenario.

### DETAILED DESCRIPTION OF THE EMBODIMENTS

The technical solutions in the embodiments of this application are clearly and completely described below with reference to the drawings in the embodiments of this application. Apparently, the described embodiments are only some rather than all of the embodiments of this application. All other embodiments obtained by those of ordinary skill in the art based on the embodiments of this application without creative efforts should fall within the protection scope of this application.

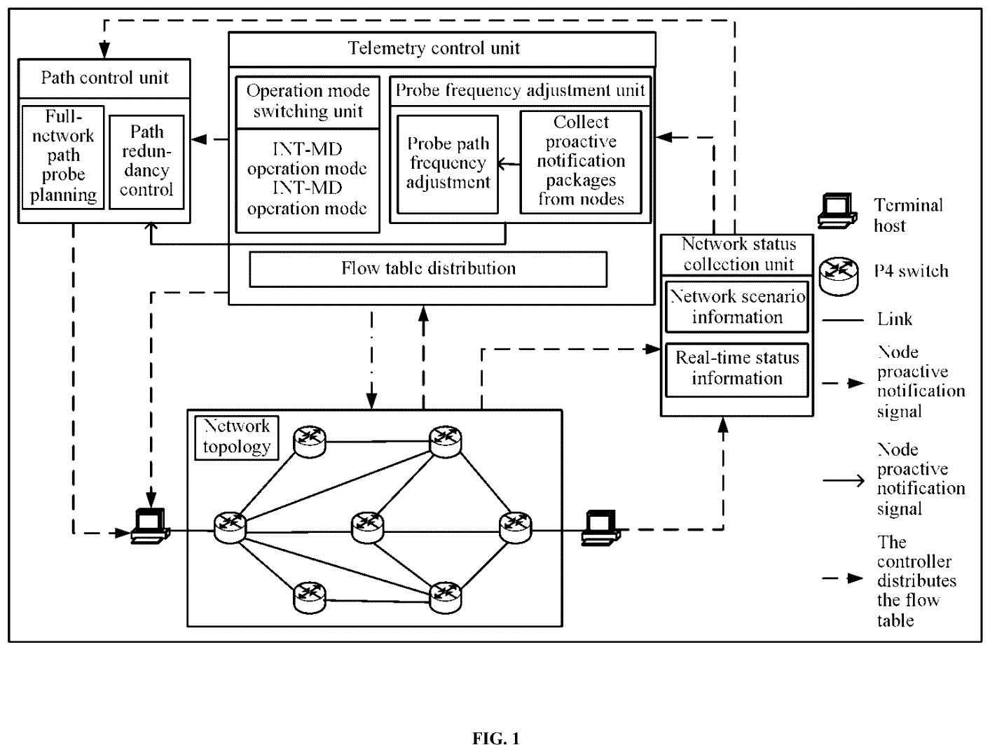

FIG. 1 is a general framework diagram of the present disclosure. As shown in FIG. 1, a scenario-differentiated network telemetry method according to the present disclosure adopts an SDN architecture. Compared to a conventional architecture in which a network control plane and data plane are integrated within a network device, the SDN architecture separates the control plane from the data plane. The control plane is managed by a central controller, while the data plane includes a network device to execute actual packet processing. Moreover, the central controller is utilized for decision-making across the entire network. With the programmatic flexibility of the controller, the SDN becomes more programmable, allowing for adjustments to network behaviors as needed. Further, new protocols and services are supported, offering greater flexibility and innovation space for the network, making the network adaptable to new applications and services. The data plane uses a P4 programmable switch to support functions of network nodes, enhancing network flexibility, customizability, and programmability. This allows network devices to better adapt to the constantly changing network environments and requirements, providing more room for advanced optimization, innovation, and management of the network.

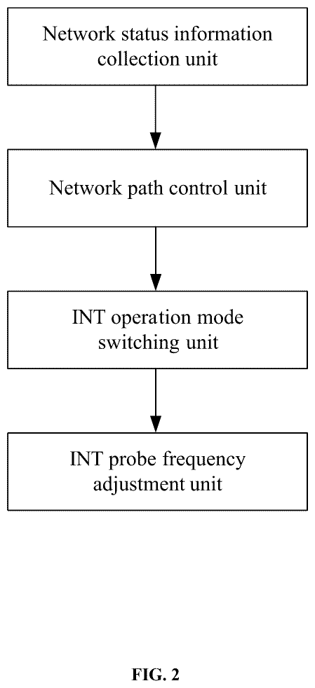

FIG. 2 is a schematic structural diagram of units in a scenario-differentiated network telemetry method according to the present disclosure. As shown in FIG. 2, the present disclosure includes a network status collection unit, an operation mode switching unit, a probe frequency adjustment unit, and a path control unit. The operation mode switching unit and the probe frequency adjustment unit are included in a telemetry control unit.

The network status collection unit is configured to collect network scenario information and real-time status information, the network scenario information describes information about a service scenario to which the technology is applied, enabling selection of different operation modes for path probe and adjustment of a probe frequency; and the real-time status information is collected node metadata that accurately reflects an network situation, to facilitate timely regulation of a telemetry strategy, and ensure flexibility and reliability of network probe;
the operation mode switching unit selects a telemetry mode according to characteristics of different network scenarios, path statuses, and features of different INT operation modes through data collected by the network status collection unit;
the probe frequency adjustment unit is configured to receive a proactive sensing notification from an network node, so as to adjust the probe frequency; and
the path control unit is configured to generate, according to a network topology, a plurality of probe paths that evenly cover the network nodes; and re-plan the probe paths based on adjustments to the probe frequency.

A specific working procedure includes the following steps:
Step S1: Perform initial path planning for a network scenario attribute, and the network collection unit obtains all network information with an aim of covering all network links.

Network attributes are considered in multiple dimensions, and selection of the operation mode is based on the network scale. For example, for large-scale networks with a larger average number of hops along the path, a hop-by-hop probe mode is selected to avoid issues such as incomplete information collection or excessive information redundancy due to the packet length limitations caused by too many hops. For small-scale topologies or topologies with simpler node connections, an in-situ flow probe mode is used, utilizing fewer probe packets to recover network resources. For different network scenarios, such as those with severe packet loss, one of the major challenges in probing network information is the loss of probe packets during transmission. Therefore, a hop-by-hop probe mode is adopted to cover as much network node information as possible. For network scenarios requiring high real-time performance, where the real-time requirements for obtaining network resources are high, and the time difference for recovering information through multiple probe paths needs to be small, path planning is carried out reasonably based on the hop-by-hop probe mode.

Step S2: The path control unit generates, according to the network topology and the information fed back by the network collection unit, the plurality of probe paths evenly covering the network nodes.

Step S3: Perform operation mode selection for different network scales or different network scenarios based on the information collected in the step S1.

Step S4: After collection of the network information is completed, send the network information into the network scenario information of the network status collection unit for storage; and further adjust the probe mode using network resource information, to improve the system flexibility. Specifically, the network status collection unit serves the purposes of probe path re-planning, probe frequency optimization, and node probe action adjustment.

Probe path re-planning has two functions. First, network scenario information, a real-time link transmission status and a node queue depth provided in real-time recovered network status information, or a real-time feedback of other landmark network conditions are used to ensure high coverage of network information probe links and high volume of information collection from network resources in combination with scenario requirements. Second, a separate probe path is set for an abnormal node, such as a node with a queue depth or transmission latency exceeds a specified threshold, which may lead to transmission issues. A hop-by-hop probe mode is adopted to ensure accuracy and completeness of collected probe information. Furthermore, to prevent node deterioration caused by probe behaviors, a path redundancy is performed on an upstream node directly connected to the abnormal node, to avoid excessive probing traffic passing through the abnormal node.

The probe frequency optimization includes real-time updates to probe frequencies for different paths based on an initial probe frequency and an update rate of the network information. For example, assume that four probe paths are needed to collect link information across the entire network. If one of these paths includes a plurality nodes with frequent switching behaviors, it requires more frequent probe of the inter-node links. To ensure information timeliness, a higher frequency is set for this path.

Adjustment of node probe actions primarily focuses on switching probe methods and selecting a probe action for an network abnormal node, including: selecting and switching to an appropriate operation mode for the node based on changes in the network scenarios or link conditions. Since the network node has a proactive sensing function, the node detects a network anomaly timely, and performs a proactive information upload action, enhancing a capacity of the entire system for processing anomalies.

Therefore, the network status collection unit, the operation mode switching unit, the probe frequency adjustment unit, and the path control unit are functionally independent but mutually supportive, and the real-time performance and accuracy of sensing are ensured through continuous adjustments of probe behaviors based on the network status information and constant feedback.

The operation mode switching unit includes a hybrid sensing mode switching method based on the network scenario information or a dynamically adjusted sensing method based on network status changes.

The hybrid sensing mode switching method based on the network scenario information is specifically described as follows:

To address the efficiency and accuracy issues of network information sensing in complex network scenarios, a hybrid sensing switching method based on INT is proposed. INT is a hybrid measurement technology that fundamentally collects, carries, organizes, and reports network statuses using data plane services, without using a separate control plane to manage traffic for this information collection. The INT technology involves three functional nodes, providing different functions. For telemetry managers, service traffic requiring telemetry is marked at a source node by adding an INT header, which includes an instruction set specifying types of information to be collected, thereby transforming the packet into an INT packet. Upon reaching an INT transit node, collected information is inserted into the INT packet according to the instruction set. Finally, at an INT sink node, all INT information is extracted and sent to a monitoring device.

a. Introduction to INT Operation Modes:

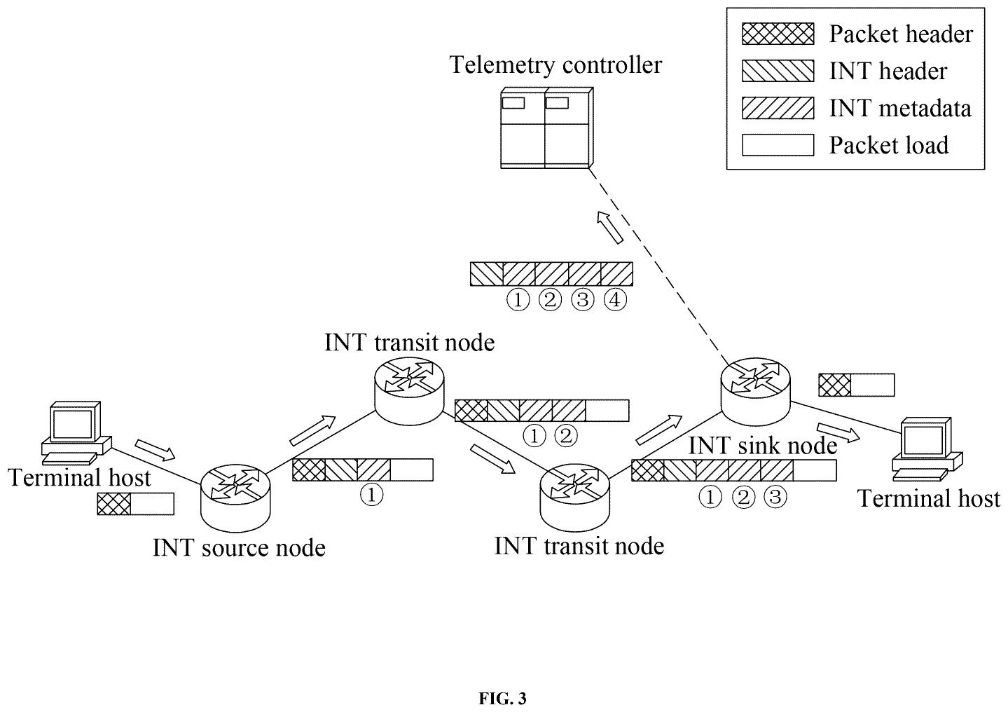

The INT standard defines three operation modes: In the classic in-band INT mode, also known as INT-eMbed Data (INT-MD) mode, an INT source node embeds instructions into a forwarded service packet. As the packet traverses INT transit nodes, metadata is added hop-by-hop. Finally, an INT sink node strips the instructions from the packet and sends accumulated telemetry data to a telemetry controller. This operation mode is shown in FIG. 3.

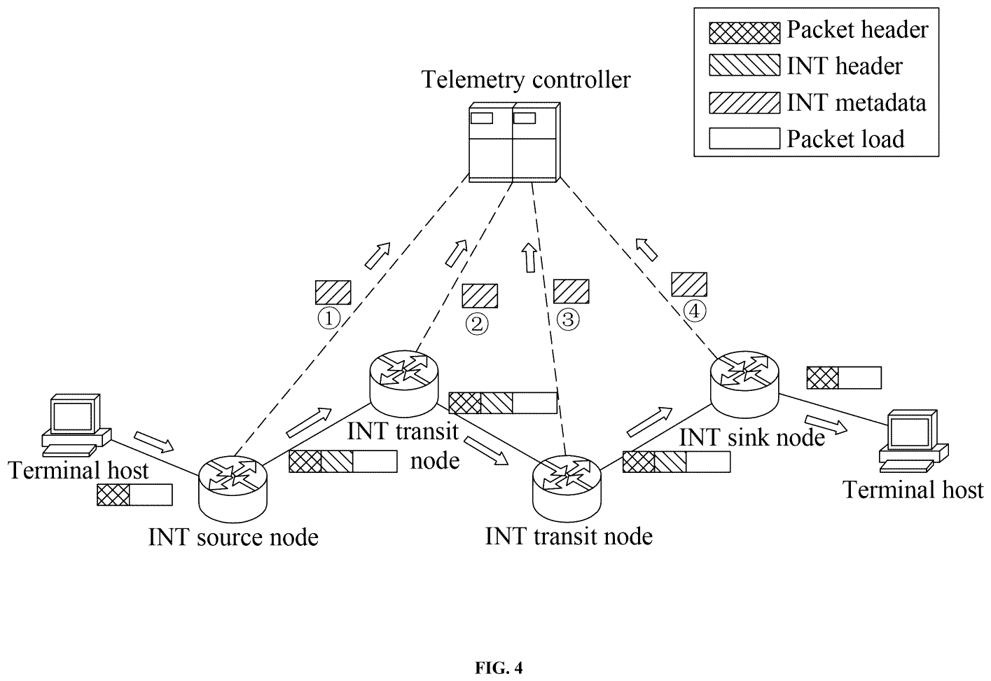

Building on the in-band approach, the INT-cMbed instruct (X) ions (INT-MX) mode improves by feeding metadata hop-by-hop back to the controller. In this mode, the source node adds INT instructions to the packet header. Each subsequent transit node encapsulates telemetry information into metadata based on the INT instructions, forming a report packet that is forwarded directly to a telemetry server. The INT sink node strips the INT header before forwarding the packet to the receiver. The packet modification in this mode is limited to the instruction header and the packet size does not increase as the packet passes through more devices during the monitoring process. This reduces the processing complexity of forwarding devices and avoids the limitation of maximum transmission unit (MTU) in the telemetry process. However, the per-packet, per-hop telemetry INT mode, introduces additional out-of-band bandwidth overhead and increases data integration and processing pressure on a data analysis system. This operation mode is shown in FIG. 4.

Based on INT-MX, the INT-export Data (XD) mode allows network switches to export metadata directly from the data plane to the telemetry monitoring system according to preconfigured INT instructions in the Flow Watchlists, without modifying the packet. Since the INT packet uses a flag bit only, this mode is heavily dependent on the Flow Watchlists preconfigured by network administrators and lacks the flexibility for deployment of customized monitoring solutions as required. For this reason, this operation mode is not considered for implementation in the present disclosure.

The categories of metadata that collected by the INT technology are shown in the following Table 1:

TABLE 1
Categories of metadata collected by the INT technology

| Metadata category | Information name | Information description |
|---|---|---|
| Switch Level | switch_id | A globally unique identifier |
| | | assigned to a switch |
| | control_plan_state_version umber | Each time a control plane |
| | | changes the status (for example, |
| | | IP FIB updates), the version |
| | | number can also be updated by |
| | | the control plane in a data plane |
| Ingress Information | ingress_port_id | Port for receiving packets |
| | ingress_timestamp | Local time on a device when an |
| | | ingress port receives a packet |
| | ingress_port_RX_pkt_count | Total number of packets received |
| | | at an ingress port for receiving |
| | | packets |
| | ingress_port_RX_byte_count | Total number of bytes received at |
| | | an ingress port for receiving |
| | | packets |
| | ingress_port_RX_drop_count | Total number of packets dropped |
| | | at an ingress port for receiving |
| | | packets |
| | ingress_port_RX_utilization | Quantified rate of receiving |
| | | packets at an ingress port |
| Egress Information | egress_port_id | ID of a port for forwarding |
| | | packets |
| | egress_timestamp | Local time on the device when |
| | | the packet leaves an engress port |
| | egress_port_TX_pkt_count | Total number of packets |
| | | forwarded through an engress |
| | | port |
| | egress_port_TX_byte_count | Total number of bytes in packets |
| | | forwarded through an engress |
| | | port |
| | egress_port_TX_drop_count | Total number of packets dropped |
| | | when forwarded to an engress |
| | | port |
| | egress_port_TX_utilization | Current utilization rate of an |
| | | engress port for sending packets |
| Buffer Information | queue_id | Queue ID of a device for |
| | | processing packets |
| | instantaneous_queue_length | Instantaneous length (in bytes, |
| | | cells, or packets) of the queue |
| | | observed in the device when the |
| | | packet is forwarded |
| | average_queue_length | Average length (in bytes, cells, |
| | | or packets) of the queue that |
| | | provides packets |
| | congestion_status | Ratio of the current queue length |
| | | to a configured maximum queue |
| | | threshold |
| | queue_drop_count | Total number of packets |
| | | discarded by the queue |
| Miscellaneous | checksum_complement | Checksum and complement |

The use of basic metadata enables internal information sensing within switch nodes. On this basis, further detailed network information measurements can be achieved through customized sensing information based on secondary sensing information processing. Details are shown in the following Table 2:

TABLE 2
Customized sensing information

| Information name | Information description |
|---|---|
| node_pkt_drop_count | Total number of packets dropped by a node |
| node_byte_pro_time | Time taken by a node to process packets |
| node_byte_pro_count | Total number of packets processed by a node |
| route_hop_count | Total number of hops traversed by a path |
| route_trace_rtt | Round trip time of a path |
| route_hop_throughput | Instantaneous throughput of a node |
| | traversed by a path |
| send_probe_count | Total number of probe packets sent |
| receive_probe_count | Total number of probe packets received |

b. Introduction to Node Proactive Sensing Function

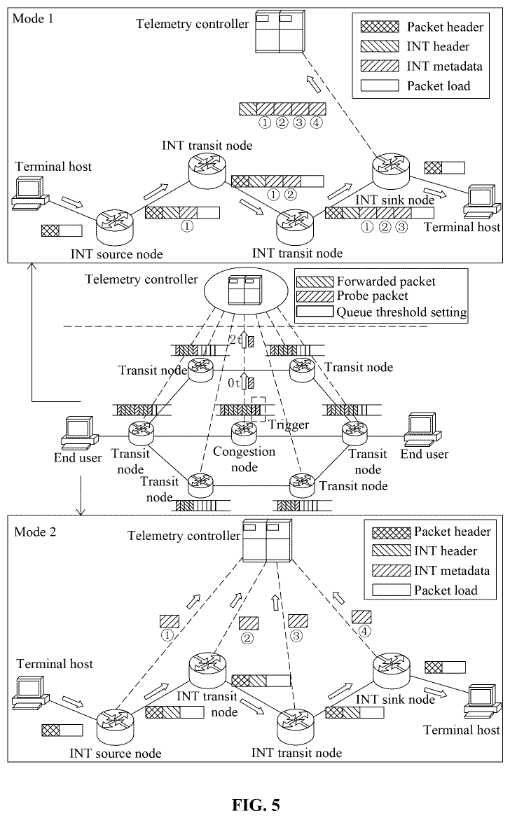

To address the current limitation of single INT operation modes in sensing coverage, the present disclosure integrates two operation modes of collecting telemetry data, namely in-band sensing and hop-by-hop upload of sensing information, and enables mechanism switching based on different network scenario requirements (such as network scales) to achieve better sensing performance. Considering the universality of mechanism switching across various network scenarios, the present disclosure initially adopts the in-band sensing mode to perform broadcast within unknown scenarios with reference to the network scale, thereby obtaining the topology information of the entire network. Whether to switch is determined based on feedback information and a switching trigger condition. An operation mode switching unit is designed to switch to an appropriate mode for a corresponding scenario, thereby ensuring efficient telemetry tasks. Based on INT operation mode switching, the present disclosure further designs a function of autonomously probing network situation changes between the nodes, to address the timeliness sensing information. This operation mode is shown in FIG. 5.

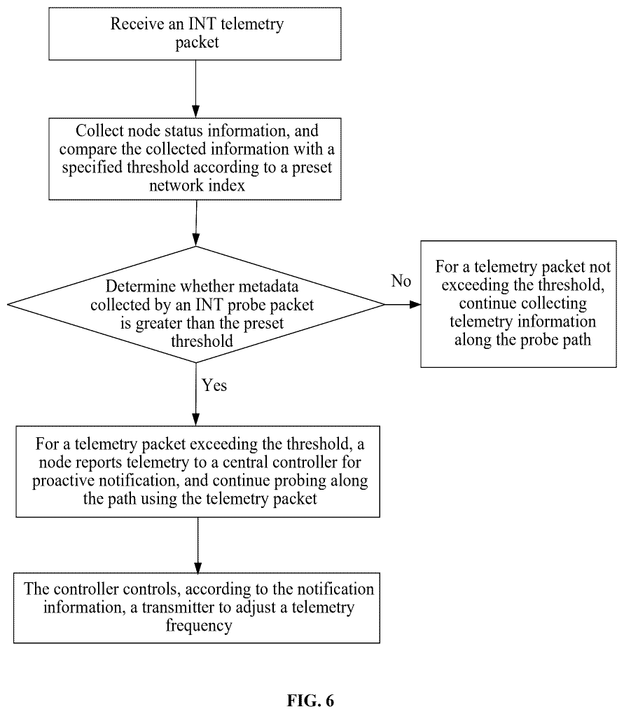

Using node queue depth as a reference element for triggering proactive sensing, network congestion is measured based on the node queue depth, to enable timely sensing data updates. As shown in FIG. 6, all network nodes are provided with the proactive notification function. When network anomalies occur, congestion degree is taken as the determining standard. If the queue depth exceeds an initial threshold configured per network scenario, the congestion determining condition is met, and the congested node proactively reports real-time network status by sending INT probe packets to the remote telemetry controller. Moreover, the setting flexibility of the node proactive notification function is high, and the frequency can be dynamically adjusted according to the ratio of exceeding the threshold.

As shown in FIG. 6, a specific method includes:

Step SI: Receive an INT telemetry packet.

Step SII: Collect node status information, and compare the collected information with a specified threshold according to a preset network index.

Step SIII: Determine whether metadata collected by an INT probe packet is greater than a preset threshold; and if not, proceed to step SIV; otherwise, proceed to step SV.

Step SIV: For a telemetry packet not exceeding the threshold, continue collecting telemetry information along the probe path.

Step SV: For a telemetry packet exceeding the threshold, a node reports telemetry to the central controller for proactive notification, and continue probing along the path using the telemetry packet.

Step SVI: The central controller controls, according to the notification information, a sender to adjust a telemetry frequency.

c. The hybrid sensing mode switching method based on the network scenario information:

Based on the two INT operation modes and the network node sensing function, the method first analyzes sensing requirements of the network scenario. For instance, scenarios requiring high real-time performance demand minimal latency in sensing data collection, while in anti-packet loss scenarios, the amount of collected sensing information is large, that is, the exploration cycle of the sensing coverage, needs to be more frequent. Therefore, a multi-objective optimization problem for different scenario requirements is constructed, thereby selecting reasonable information according to priorities of the sensing requirements in different scenarios.

Secondly, according to a hybrid telemetry switching model, a constraint condition set is constructed based on constraints including network resource availability, dependencies of scenario telemetry requirements, probe path directions, and sensing effect requirements. For example, in an anti-packet loss scenario, poor network conditions may cause loss of the network status information during probing, and affects the network telemetry coverage. It is preferable to adopt the hop-by-hop upload mode to collect initial network status information.

After collecting the status information of the entire network, the topology areas can be divided based on the busyness of the node switching behaviors and the packet loss situation on the link. For the probe path including nodes with frequent switching behaviors, the INT operation mode of hop-by-hop information upload is maintained. For nodes with less link packet loss and moderate switching status, the INT operation mode of in-band information upload is selected. The network status refinement and adjustment in the probe operation mode are completed, and the path redundancy planning and other constraint methods are introduced to avoid the bandwidth loss and congestion aggravation caused by repeated probing on congested links.

During the periodic sensing process of the network information, when an abnormal node is detected, a probe path that covers the abnormal node senses anomalies in network resource information, such as a sudden increase in queue depth or abnormal transmission latency between nodes. Based on scenario-specific high-priority resource indicators, the method adjusts probe paths and further refines the operation modes.

Specifically, in the anti-packet loss scenario, given the high priority of queue depth, when an anomaly occurs at an network node, that is, when the queue depth exceeds the predefined threshold, the proactive sensing function of the node enables information upload. Simultaneously, the probe frequency of the probe path on which the abnormal node is located is increased, and the INT operation mode of hop-by-hop information upload is selected to effectively monitor the status changes of the abnormal node, thereby providing real-time information for subsequent adjustments.

If the node anomaly persists after multiple rounds of adjustment of the probe mode based on the information fed back by the abnormal network node, only the proactive sensing function is enabled for the abnormal node, and the network status probe path excludes the abnormal node during path planning. This ensures the rapid update of node information while preventing secondary impacts on the abnormal node from the probe path.

The dynamically adjusted sensing method based on network status changes is described below with two typical network scenarios:

In an adaptive switching framework, considering a complex network situation and different telemetry data collection requirements, a sensing parameter threshold is set based on flexible switching between sensing operation modes, and the node dynamically adjusts the probe frequency as needed, such that more measurement possibilities is realized by dynamic interaction between the nodes, and flexible and efficient telemetry tasks are realized. Below, two typical network scenarios, one with high requirements on real-time performance and another with varying packet loss severities, are used as examples for application explanations.

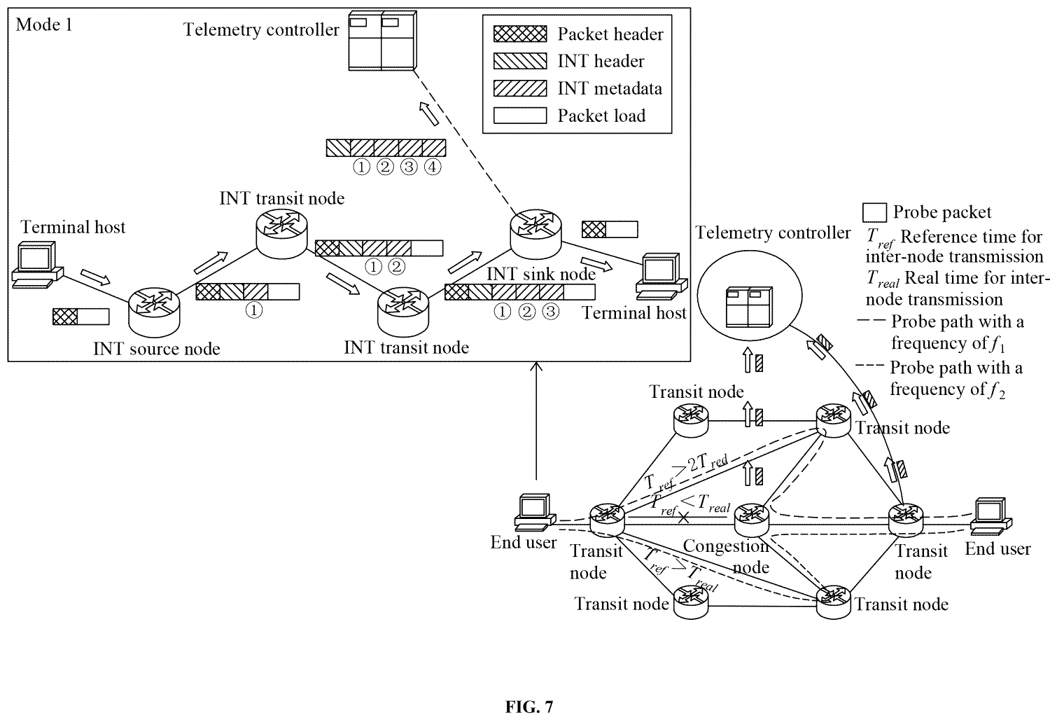

a) Scenarios with high requirements on real-time performance: For networks with high requirements on real-time performance, the requirements on the speed of network information collection are even higher. A value can be set for transmission time between congested nodes as the reference time. The frequency of node proactive sensing is correspondingly increased or decreased according to the degree of exceeding or falling below the reference time. While ensuring full node coverage, paths with shorter sensing time are prioritized based on inter-node transmission latency. Dynamic path selection is implemented during sensing. Using the operation mode 1 as an example, the workflow is shown in FIG. 7.

Automatic sensing switch strategy for scenarios with high requirements on real-time performance:

In the scenarios with high requirements on real-time performance, the response speed of the network is very important, and the sensing switching needs to be fast and accurate.

Dynamic latency monitoring: Monitor latency indicators of all paths in real time and compare in real time with a preset threshold.

Dynamic sensing mode switching: When the latency of a specific path exceeds the threshold, the system automatically switches to a higher-frequency sensing mode. Conversely, if the latency falls below the threshold, the probe frequency is decreased to optimize resource utilization.

Priority path selection: Based on real-time data, dynamic selection is carried out with latency as the core indicator. Multiple non-overlapping probe paths with low latency are selected for probe path selection of the probe packet, to ensure high-speed response for critical services.

Emergency response mechanism: For sudden high-latency events, the probe frequency is increased. For abnormal nodes, network information is reported for multiple times, and probing and service path switching are urgently initiated to rapidly locate and resolve issues.

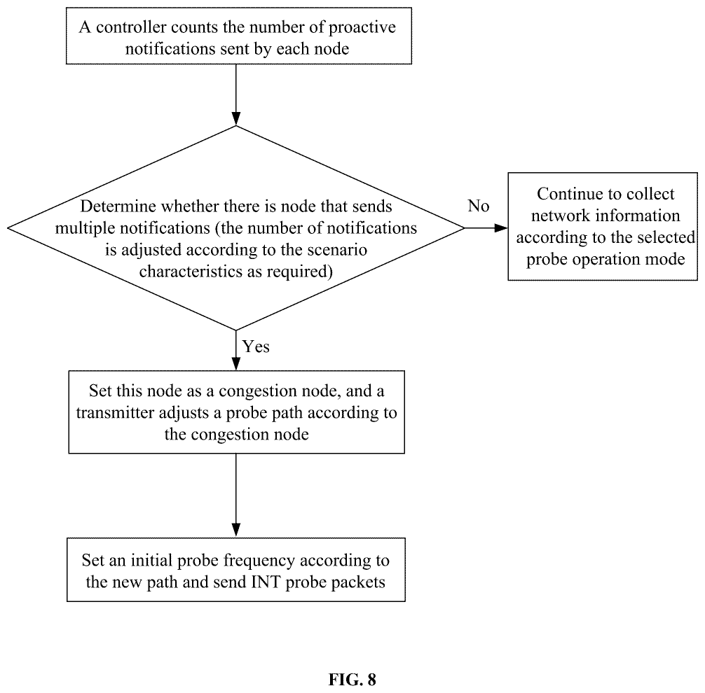

b) FIG. 8 is a flowchart of dynamically adjusting the probe path based on the network status changes. As shown in FIG. 8, for scenarios with different packet loss severities:

In scenarios with different packet loss severities, based on the switching mechanism of INT operation modes, with reference to the queue depth, the congested nodes are selected and excluded from path planning using path redundancy controls. INT selects a path passing through nodes with globally smaller queue depth for path planning and sensing. The congested nodes proactively send one or more probe packets based on the degree of threshold exceedance, to updates the network information, addressing INT packet loss and achieving more precise sensing measurement effect. Automatic sensing switch strategy for scenarios with different degrees of packet loss:

When facing different packet loss severities, it is particularly important to ensure that the collected network information is not lost.

Real-time monitoring of queue depth: Continuously monitor the queue depth of each node in the network to adjust the probe strategy.

Packet loss sensitivity adjustment: Dynamically adjust the sending frequency and path selection of probe packets according to the queue depth and packet loss rate. For nodes with high packet loss rate, increase the probe frequency for close monitoring and adjustment.

Path redundancy and selection: When a path with high packet loss rate is detected, the path redundancy mechanism is automatically introduced to select a backup path to maintain the comprehensiveness of network information collection.

Fast response to packet loss events: Once the packet loss events are detected to exceed the preset threshold, the node proactive sensing behavior is triggered immediately, and the routing is adjusted quickly to reduce the impact.

Through these automatic sensing switching strategies, the network can dynamically adjust telemetry and path planning according to the different requirements on real-time performance and packet loss, thus effectively improving the stability and performance of the network. This dynamic adjustment not only improves the adaptive capability of the network, but also ensures the continuity and efficiency of key applications.

### c) Adapting to Changing Network Scenarios:

When the network scenario changes, for instance, from a low-latency scenario to a high packet loss rate scenario, the system needs to rapidly detect the change and adjust the probe strategy to adapt to the new environment, requiring high system flexibility and adaptability. The following uses an example of changing from low-latency scenario to a high packet loss scenario to illustrate an automatic sensing strategy adjustment process, to cope with the changing scenarios:

### 1. Scenario Identification and Evaluation:

Data analysis: The system continuously analyzes the collected telemetry data (such as the latency, packet loss rate, and bandwidth), and uses a statistical method to predict the changing trend of the network status.

Scenario determining: When the data shows that the packet loss rate increases significantly and the latency problem is no longer the primary problem, the system automatically identifies the scenario as a scenario with high packet-loss rate.

### 2. Strategy Switching and Parameter Adjustment:

Probe frequency adjustment: In the scenario with high packet loss rate, increase the transmission frequency of the probe packet, so as to monitor the network status more intensively and quickly find the source of the problem.

Path optimization: Automatically adjust the data transmission path according to the historical network status information, prioritize the path with low packet loss rate, and add redundant paths when abnormal nodes are found in the network, to prevent data loss.

### 3. Fault Diagnosis and Recovery:

Real-time diagnosis: The system uses multi-dimensional probe data information to locate the fault point, identifying whether packet loss is caused by network congestion or device failure. Network congestion usually occurs when network traffic is overloaded, and data packets are discarded because the processing capacity of a network path or node is exceeded. In this case, packet loss is typically associated with traffic surges during peak periods or on specific paths. The issue can be mitigated by enabling nodes to send multiple sensing notifications and collect probe path indicators. Device failure, on the other hand, may result from hardware or software issues in a forwarding device (such as the router or switch) in the network, preventing properly processing passing packets. Packet loss caused by device failure is typically random and not correlated with traffic changes, making it difficult to alleviate through node probe behaviors.

Automatic recovery: Once the cause of the fault is identified, the system attempts to resolve the issue automatically through recovery measures, for example, bypassing the faulty node through routing adjustment or automatically triggering device restart.

### 4. Performance Monitoring and Feedback Adjustment:

Continuous monitoring: After adjustments are completed, the system continuously monitors network performance to evaluate the effectiveness of the implemented measures. This includes determining whether information collection is comprehensive and whether collection latency remains consistent, while remaining prepared to fine-tune the strategy further if needed.

Feedback mechanism: The system gathers performance data following strategy implementation and feeds the data back into the strategy adjustment algorithm to optimize future decision-making.

By automatically adjusting sensing strategies, the network management system can respond to changes in different network scenarios in real time, ensuring stable network operations and continuous service delivery. This dynamic adjustment strategy not only enhances the network's adaptability but also significantly improves its reliability and the overall user experience.

The present disclosure further provides a network telemetry apparatus adopting the scenario-differentiated network telemetry method, including:
a central controller for managing a control plane, and a data plane for a network device to execute actual packet processing, where the central controller is utilized for decision-making across an entire network, and the data plane adopts a P4 programmable switch to support functions of network nodes; and
a network status collection unit, an operation mode switching unit, a probe frequency adjustment unit, and a path control unit, where the operation mode switching unit and the probe frequency adjustment unit are included in a telemetry control unit, where
the network status collection unit is configured to collect network scenario information and real-time status information, the network scenario information describes information about a service scenario to which the technology is applied, enabling selection of different operation modes for path probe and adjustment of a probe frequency; and the real-time status information is collected node metadata that accurately reflects an network situation, to facilitate timely regulation of a telemetry strategy, and ensure flexibility and reliability of network probe;
the operation mode switching unit selects a telemetry mode according to characteristics of different network scenarios, path statuses, and features of different INT operation modes through data collected by the network status collection unit;
the probe frequency adjustment unit is configured to receive a proactive sensing notification from the network node, so as to adjust the probe frequency;
the path control unit is configured to generate, according to a network topology, a plurality of probe paths that evenly cover the network nodes; and re-plan the probe path based on adjustments to the probe frequency; and
the network status collection unit, the operation mode switching unit, the probe frequency adjustment unit, and the path control unit are functionally independent but mutually supportive, and the real-time performance and accuracy of sensing are ensured through continuous adjustments of probe behaviors based on the network status information and constant feedback.

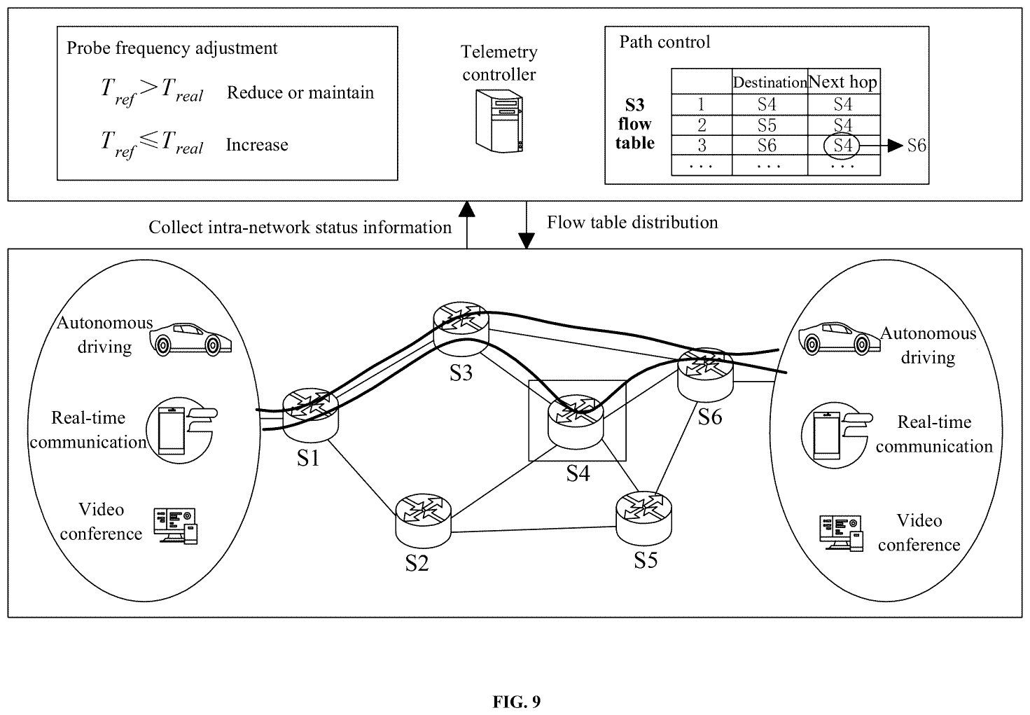

The following describes of a specific process in which the present disclosure is applied to a low-latency scenario in combination with FIG. 9:

This example adopts a network optimization framework to dynamically adjust network paths and telemetry strategies in real time, to respond to abnormalities within the network and maintain key performance indicators such as low latency. The following provides a detailed explanation of a specific implementation process of the present disclosure, covering steps such as packet transmission, receiving, and processing. As shown in FIG. 9, the present disclosure can be applied to various scenarios. Dual-level sensing adjustment is performed by both the packet sender and the network nodes based on the scenario characteristics. The framework of the present disclosure includes functional descriptions of both the terminal devices and network nodes. Taking a low-latency scenario as an example, where demand is increasing for services such as real-time communication and autonomous driving, the present disclosure offers support to these scenarios to ensure the reliability and real-time performance of information transmission.

In FIG. 9, the lower forwarding plane performs data transmission and information collection along the initial probe path. If an network node becomes abnormal, for instance, if metadata collected by a probe packet at a node S4 shows transmission latency exceeding a specified threshold, continuing to select paths passing through this node may result in localized network congestion.

In response to such anomalies, the abnormal node in the forwarding plane notifies the control plane to adjust the telemetry strategy. Upon receiving the abnormal information, the control plane may take the following actions:
\textcircled{1} Adjust the path, that is, according to the abnormal node, adjust the path selected by the previous-hop node, to bypass the abnormal node, and divert the telemetry data through the upstream node to alleviate the abnormal situation. Alternatively, a dedicated probe path can be designed for the abnormal node to isolate other interference and improve the accuracy of data collection for the node.

\textcircled{2} If the anomaly persists or the number of anomalies exceeds an initially specified value, the controller cannot recover normal transmission in the network by adjusting a single node for troubleshooting according to the degree of anomaly, such as transmission latency, which is an important indicator of low-latency scenarios.

In such cases, the sender resets the probe path and frequency to resolve the anomaly, and shifts from a passive action to a proactive adjustment approach, significantly accelerating both fault resolution and information collection.

### Specific Implementation Process:

### 1. Initialization Phase:

Sender configuration: The sender presets a probe path based on service requirements and sets the frequency for sending probe packets (for example, once per second).

Telemetry configuration: Each network node is equipped with basic telemetry functions, which can intercept passing probe packets, collect key parameters such as the latency and packet loss rate, and insert telemetry information into the INT probe packets according to telemetry instructions.

### 2. Probe Packet Transmission and Collection:

Packet generation and transmission: the sender sends probe packets periodically, and each packet includes a unique identifier and a transmission time stamp.

Data collection: Network nodes capture passing probe packets, record latency and abnormal indicators, and add the data into the packet metadata

### 3. Anomaly Detection and Response:

Anomaly detection: Each node analyzes passing probe packets. If a scenario-sensitive indicator (such as latency in low-latency scenarios) exceed a preset threshold, the node marks the packet as abnormal.

Packet reporting: The node adds metadata to the abnormal packet and sends the packet to the control plane.

Control plane analysis and decision-making: After receiving the abnormal information, the control plane makes a quick analysis and decides subsequent operations. The operations include:
\textcircled{1} Path adjustment: If the anomaly is local, the control plane instructs relevant upstream nodes to bypass the abnormal nodes and select a backup path for data transmission.

\textcircled{2} Increase the probe frequency: For persistent or severe anomalies, the probe frequency on the node or path may be increased to monitor the issue more closely.

\textcircled{3} Dedicated probe path design: A dedicated probe path is designed for abnormal nodes to eliminate other traffic interference. These nodes are monitored and adjusted, while redundant path planning is carried out for other nodes. The graph-theory-based path optimization algorithms may be applied to exclude abnormal nodes from path calculations.

### 4. Dynamic Adjustment and Optimization:

Real-time adjustment of probe paths: The control plane dynamically updates the probe paths based on real-time feedback of the network status.

Information feedback loop: Updated paths and strategies are fed back to the sender, so as to adjust probe settings according to the current network status.

5. Troubleshooting and reporting:

Implementation of troubleshooting measures: Monitor the paths and nodes in real time during the system operation, and implement specific troubleshooting measures, such as hardware replacement and software upgrade, on the nodes or paths with identified problems.

Performance reporting: Periodically generate network performance reports, including overall and local performance indicators of the network, as well as evaluations of the effectiveness of the applied measures.

This detailed implementation process ensures efficient network operation and supports the smooth functioning of critical applications (such as real-time communication and autonomous driving), particularly in scenarios requiring low latency and high reliability.

The present disclosure further provides an electronic device, including a processor and a memory, where when the processor executes a computer program stored in the memory, the above scenario-differentiated network telemetry method is implemented.

The present disclosure further provides a computer readable storage medium, storing a computer program, where when the computer program is executed by a processor, the above scenario-differentiated network telemetry method is implemented.

The scenario-differentiated network telemetry method and apparatus according to the present disclosure integrate relevant technologies such as P4, INT, and path planning to address the increasing complexity and diversity of network statuses, and the challenges posed by the limited flexibility of sensing modes, low timeliness of sensing information, and the lack of dynamic adaptability in INT schemes. Based on the characteristic attributes of different service scenarios, the method selects a sensing operation mode according to prioritized requirements to obtain status information across the entire network. Abnormal conditions are sensitively detected through proactive behaviors of network nodes, enabling real-time sensing updates to telemetry data. Ultimately, the method enables efficient, network-wide monitoring, real-time network status assessment, and precise handling of abnormal conditions. From this perspective, it is difficult to find other alternative solutions capable of achieving the objectives of the present disclosure. However, in the specific implementation process, other telemetry technologies, such as In-band Operations, Administration, and Maintenance (IOAM), may be adopted. IOAM offers two operation modes that are functionally equivalent to INT and also operate in-band. These alternatives are expected to deliver comparable results, demonstrating the scalability and extensibility of the proposed solutions.

Persons skilled in the art may realize that, the units and the algorithm steps of the examples described in the embodiments of the present disclosure can be implemented by electronic hardware, computer software, or a combination thereof. In order to clearly describe the interchangeability between the hardware and the software, compositions and steps of each example have been generally described according to functions in the foregoing descriptions. Whether the functions are performed by hardware or software depends on particular applications and design constraints of the technical solutions. Those skilled in the art may use different methods to implement the described functions for each specific application, but such implementation should not be considered to be beyond the scope of the present application.

The steps of the method or algorithm described in the embodiments of the present disclosure may be directly embedded in hardware, in a software module executed by a processor, or in a combination of both. The software modules may reside in random access memory (RAM), a memory, a read-only memory (ROM), an electrically programmable ROM (EPROM), an electrically erasable programmable ROM (EEPROM), a register, a hard disk, a removable disk, a compact disc ROM (CD-ROM), or any other form of storage medium known in the art.

Finally, it should be further noted that, in this description, relationship terms such as first and second are only used to distinguish an entity or operation from another entity or operation, but do not necessarily require or imply that there is any actual relationship or order between these entities or operations. In addition, terms “include”, “comprise”, or any other variations thereof are intended to cover non-exclusive including, so that a process, a method, an article, or a device including a series of elements not only includes those elements, but also includes other elements that are not explicitly listed, or also includes inherent elements of the process, the method, the article, or the device. Without more restrictions, the elements defined by the sentence “including a . . . ” do not exclude the existence of other identical elements in the process, method, article, or device including the elements.

The scenario-differentiated network telemetry method and apparatus according to the present disclosure are described in detail above. The principles and implementations of the present disclosure are described herein by using specific examples. The description of the embodiments is merely provided to help understand the method and core idea of the present disclosure. In addition, a person of ordinary skill in the art can make variations and modifications on the specific implementations and application scope according to the idea of the present disclosure. Therefore, content of this specification shall not be construed as a limitation on the present disclosure.

What is claimed is:

1. A scenario-differentiated network telemetry method, wherein the method is based on a software defined network (SDN) architecture, a control plane is separated from a data plane, the control plane is managed by a central controller, the data plane comprises a network device to execute actual packet processing, and the central controller is utilized for decision-making across an entire network; the data plane employs a P4 programmable switch to support functions of network nodes; and units of the method comprise a network status collection unit, an operation mode switching unit, a probe frequency adjustment unit, and a path control unit, wherein the operation mode switching unit and the probe frequency adjustment unit are comprised in a telemetry control unit, wherein
the network status collection unit is configured to collect network scenario information and real-time status information, the network scenario information describes information about a service scenario to which a technology is applied, enabling selection of different operation modes for path probe and adjustment of a probe frequency; and the real-time status information is collected node metadata that accurately reflects an network situation, to facilitate timely regulation of a telemetry strategy, and ensure flexibility and reliability of network probe;
the operation mode switching unit selects a telemetry mode according to characteristics of different network scenarios, path statuses, and features of different In-band Network Telemetry (INT) operation modes through data collected by the network status collection unit;
the probe frequency adjustment unit is configured to receive a proactive sensing notification from an network node, so as to adjust the probe frequency; and
the path control unit is configured to generate, according to a network topology, a plurality of probe paths that evenly cover the network nodes; and re-plan the probe paths based on adjustments to the probe frequency;
a specific working procedure comprises the following steps:
step S1: performing initial path planning for a network scenario attribute, and obtaining, by the network collection unit, all network information with an aim of covering all network links;
step S2: generating, by the path control unit according to the network topology and the information fed back by the network collection unit, the plurality of probe paths evenly covering the network nodes;
step S3: performing operation mode selection for different network scales or different network scenarios based on the information collected in the step S1; and
step S4: after collection of the network information is completed, sending the network information into the network scenario information of the network status collection unit for storage;
and further adjusting the probe mode using network resource information, facilitating re-planning of the probe paths, optimization of the probe frequency, and adjustment of node probe actions, wherein
the network status collection unit, the operation mode switching unit, the probe frequency adjustment unit, and the path control unit are functionally independent but mutually supportive, and the real-time performance and accuracy of sensing are ensured through continuous adjustments of probe behaviors based on the network status information and constant feedback.

2. The scenario-differentiated network telemetry method according to claim 1, wherein the network node is provided with a function of autonomously probing network situation changes among the nodes, and a specific method is as follows:
step SI: receiving an INT telemetry packet;
step SII: collecting node status information, and comparing the collected information with a specified threshold according to a preset network index;
step SIII: determining whether metadata collected by an INT probe packet is greater than a preset threshold; and if not, proceeding to step SIV; otherwise, proceeding to step SV;
step SIV: for a telemetry packet not exceeding the threshold, continuing collecting telemetry information along the probe path;
step SV: for a telemetry packet exceeding the threshold, reporting, by a node, telemetry to the central controller for proactive notification, and continuing probing along the path using the telemetry packet; and
step SVI: controlling, by the central controller according to the notification information, a sender to adjust a telemetry frequency.

3. The scenario-differentiated network telemetry method according to claim 1, wherein the operation mode switching unit comprises a hybrid sensing mode switching method based on the network scenario information or a dynamically adjusted sensing method based on network status changes, and
the hybrid sensing mode switching method based on the network scenario information specifically comprises:
firstly, analyzing network scenario sensing requirements, constructing a multi-objective optimization problem for different scenario requirements, and selecting reasonable information according to priorities of the sensing requirements in different scenarios; and
secondly, according to a hybrid telemetry switching model, constructing a constraint condition set based on constraints comprising network resource availability, dependencies of scenario telemetry requirements, probe path directions, and sensing effect requirements; and
the dynamically adjusted sensing method based on network status changes specifically comprises:
in an adaptive switching framework, considering a complex network situation and different telemetry data collection requirements, setting a sensing parameter threshold based on flexible switching between sensing operation modes, and dynamically adjusting, by the node, the probe frequency as needed, such that more measurement possibilities is realized by dynamic interaction between the nodes, and flexible and efficient telemetry tasks are realized.

4. The scenario-differentiated network telemetry method according to claim 1, wherein the probe frequency adjustment unit is linked to the specified threshold of the network nodes, to perform multiple regulations of different probe frequencies according to whether the threshold is exceeded or not and a degree of exceeding the threshold.

5. The scenario-differentiated network telemetry method according to claim 1, wherein in the step S4,
re-planning of the probe path comprises, but is not limited to, using the network scenario information, a real-time link transmission status provided in real-time recovered network status information, and a node queue depth, or a real-time feedback of other landmark network situations, to ensure high coverage of network information probe links and high volume of information collection from network resources in combination with scenario requirements; or
a separate probe path is set for an abnormal node, and a hop-by-hop probe mode is adopted to ensure accuracy and completeness of collected probe information; and to prevent node deterioration caused by probe behaviors, a path redundancy operation is performed on an upstream node directly connected to the abnormal node, to avoid excessive probe traffic passing through the abnormal node.

6. The scenario-differentiated network telemetry method according to claim 1, wherein in the step S4,
the probe frequency optimization comprises real-time updates to probe frequencies for different paths based on an initial probe frequency and an update rate of the network information.

7. The scenario-differentiated network telemetry method according to claim 1, wherein in the step S4,
adjustment of node probe actions primarily focuses on switching probe methods and selecting a probe action for an network abnormal node, comprising: selecting and switching to an appropriate operation mode for the node based on changes in the network scenarios or link conditions, wherein since the network node has a proactive sensing function, the node detects an network anomaly timely, and performs a proactive information upload action, enhancing a capacity of the entire system for processing anomalies.

8. A network telemetry apparatus adopting the scenario-differentiated network telemetry method according to claim 1, comprising:
a central controller for managing a control plane, and a data plane for a network device to execute actual packet processing, wherein the central controller is utilized for decision-making across an entire network, and the data plane adopts a P4 programmable switch to support functions of network nodes; and
a network status collection unit, an operation mode switching unit, a probe frequency adjustment unit, and a path control unit, wherein the operation mode switching unit and the probe frequency adjustment unit are comprised in a telemetry control unit, wherein
the network status collection unit is configured to collect network scenario information and real-time status information, the network scenario information describes information about a service scenario to which the technology is applied, enabling selection of different operation modes for path probe and adjustment of a probe frequency; and the real-time status information is collected node metadata that accurately reflects an network situation, to facilitate timely regulation of a telemetry strategy, and ensure flexibility and reliability of network probe;
the operation mode switching unit selects a telemetry mode according to characteristics of different network scenarios, path statuses, and features of different In-band Network Telemetry (INT) operation modes through data collected by the network status collection unit;
the probe frequency adjustment unit is configured to receive a proactive sensing notification from the network node, so as to adjust the probe frequency;
the path control unit is configured to generate, according to a network topology, a plurality of probe paths that evenly cover the network nodes; and re-plan the probe path based on adjustments to the probe frequency; and
the network status collection unit, the operation mode switching unit, the probe frequency adjustment unit, and the path control unit are functionally independent but mutually supportive, and the real-time performance and accuracy of sensing are ensured through continuous adjustments of probe behaviors based on the network status information and constant feedback.

9. An electronic device, comprising a processor and a memory, wherein when the processor executes a computer program stored in the memory, the scenario-differentiated network telemetry method according to claim 1 is implemented.

10. A non-transitory computer readable storage medium, storing a computer program, wherein when the computer program is executed by a processor, the scenario-differentiated network telemetry method according to claim 1 is implemented.

11. The network telemetry apparatus adopting the scenario-differentiated network telemetry method according to claim 8, wherein the network node is provided with a function of autonomously probing network situation changes among the nodes, and a specific method is as follows:
step SI: receiving an INT telemetry packet;
step SII: collecting node status information, and comparing the collected information with a specified threshold according to a preset network index;
step SIII: determining whether metadata collected by an INT probe packet is greater than a preset threshold; and if not, proceeding to step SIV; otherwise, proceeding to step SV;
step SIV: for a telemetry packet not exceeding the threshold, continuing collecting telemetry information along the probe path;
step SV: for a telemetry packet exceeding the threshold, reporting, by a node, telemetry to the central controller for proactive notification, and continuing probing along the path using the telemetry packet; and
step SVI: controlling, by the central controller according to the notification information, a sender to adjust a telemetry frequency.

12. The network telemetry apparatus adopting the scenario-differentiated network telemetry method according to claim 8, wherein the operation mode switching unit comprises a hybrid sensing mode switching method based on the network scenario information or a dynamically adjusted sensing method based on network status changes, and
the hybrid sensing mode switching method based on the network scenario information specifically comprises:
firstly, analyzing network scenario sensing requirements, constructing a multi-objective optimization problem for different scenario requirements, and selecting reasonable information according to priorities of the sensing requirements in different scenarios; and
secondly, according to a hybrid telemetry switching model, constructing a constraint condition set based on constraints comprising network resource availability, dependencies of scenario telemetry requirements, probe path directions, and sensing effect requirements; and
the dynamically adjusted sensing method based on network status changes specifically comprises:
in an adaptive switching framework, considering a complex network situation and different telemetry data collection requirements, setting a sensing parameter threshold based on flexible switching between sensing operation modes, and dynamically adjusting, by the node, the probe frequency as needed, such that more measurement possibilities is realized by dynamic interaction between the nodes, and flexible and efficient telemetry tasks are realized.

13. The network telemetry apparatus adopting the scenario-differentiated network telemetry method according to claim 8, wherein the probe frequency adjustment unit is linked to the specified threshold of the network nodes, to perform multiple regulations of different probe frequencies according to whether the threshold is exceeded or not and a degree of exceeding the threshold.

14. The network telemetry apparatus adopting the scenario-differentiated network telemetry method according to claim 8, wherein in the step S4,
re-planning of the probe path comprises, but is not limited to, using the network scenario information, a real-time link transmission status provided in real-time recovered network status information, and a node queue depth, or a real-time feedback of other landmark network situations, to ensure high coverage of network information probe links and high volume of information collection from network resources in combination with scenario requirements; or
a separate probe path is set for an abnormal node, and a hop-by-hop probe mode is adopted to ensure accuracy and completeness of collected probe information; and to prevent node deterioration caused by probe behaviors, a path redundancy operation is performed on an upstream node directly connected to the abnormal node, to avoid excessive probe traffic passing through the abnormal node.

15. The network telemetry apparatus adopting the scenario-differentiated network telemetry method according to claim 8, wherein in the step S4,
the probe frequency optimization comprises real-time updates to probe frequencies for different paths based on an initial probe frequency and an update rate of the network information.

16. The network telemetry apparatus adopting the scenario-differentiated network telemetry method according to claim 8, wherein in the step S4,
adjustment of node probe actions primarily focuses on switching probe methods and selecting a probe action for an network abnormal node, comprising: selecting and switching to an appropriate operation mode for the node based on changes in the network scenarios or link conditions, wherein since the network node has a proactive sensing function, the node detects an network anomaly timely, and performs a proactive information upload action, enhancing a capacity of the entire system for processing anomalies.

17. The electronic device according to claim 9, wherein the network node is provided with a function of autonomously probing network situation changes among the nodes, and a specific method is as follows:
step SI: receiving an INT telemetry packet;
step SII: collecting node status information, and comparing the collected information with a specified threshold according to a preset network index;
step SIII: determining whether metadata collected by an INT probe packet is greater than a preset threshold; and if not, proceeding to step SIV; otherwise, proceeding to step SV;
step SIV: for a telemetry packet not exceeding the threshold, continuing collecting telemetry information along the probe path;
step SV: for a telemetry packet exceeding the threshold, reporting, by a node, telemetry to the central controller for proactive notification, and continuing probing along the path using the telemetry packet; and
step SVI: controlling, by the central controller according to the notification information, a sender to adjust a telemetry frequency.

18. The electronic device according to claim 9, wherein the operation mode switching unit comprises a hybrid sensing mode switching method based on the network scenario information or a dynamically adjusted sensing method based on network status changes, and
the hybrid sensing mode switching method based on the network scenario information specifically comprises:
firstly, analyzing network scenario sensing requirements, constructing a multi-objective optimization problem for different scenario requirements, and selecting reasonable information according to priorities of the sensing requirements in different scenarios; and
secondly, according to a hybrid telemetry switching model, constructing a constraint condition set based on constraints comprising network resource availability, dependencies of scenario telemetry requirements, probe path directions, and sensing effect requirements; and
the dynamically adjusted sensing method based on network status changes specifically comprises:
in an adaptive switching framework, considering a complex network situation and different telemetry data collection requirements, setting a sensing parameter threshold based on flexible switching between sensing operation modes, and dynamically adjusting, by the node, the probe frequency as needed, such that more measurement possibilities is realized by dynamic interaction between the nodes, and flexible and efficient telemetry tasks are realized.

19. The electronic device according to claim 9, wherein the probe frequency adjustment unit is linked to the specified threshold of the network nodes, to perform multiple regulations of different probe frequencies according to whether the threshold is exceeded or not and a degree of exceeding the threshold.

20. The electronic device according to claim 9, wherein in the step S4,
re-planning of the probe path comprises, but is not limited to, using the network scenario information, a real-time link transmission status provided in real-time recovered network status information, and a node queue depth, or a real-time feedback of other landmark network situations, to ensure high coverage of network information probe links and high volume of information collection from network resources in combination with scenario requirements; or
a separate probe path is set for an abnormal node, and a hop-by-hop probe mode is adopted to ensure accuracy and completeness of collected probe information; and to prevent node deterioration caused by probe behaviors, a path redundancy operation is performed on an upstream node directly connected to the abnormal node, to avoid excessive probe traffic passing through the abnormal node.
